(19) United States
(12) Patent Application Publication
(10) Pub. No.: US 2015/0106884 A1
(43) Pub. Date: Apr. 16, 2015

(54) MEMCACHED MULTI-TENANCY OFFLOAD

(71) Applicant: Broadcom Corporation, Irvine, CA (US)

(72) Inventors: Rafi Shalom, Petah Tikva (IL); Karin Inbar, Tel-Aviv (IL); Ofir Hermesh, Even Yehuda (IL)

(73) Assignee: Broadcom Corporation, Irvine, CA (US)

(21) Appl. No.: 14/511,913

(22) Filed: Oct. 10, 2014

Related U.S. Application Data
(60) Provisional application No. 62/027,817, filed on Jul. 23, 2014.
(60) Provisional application No. 61/889,777, filed on Oct. 11, 2013.

(51) Int. Cl. H04L 29/06; H04L 29/08

(52) U.S. Cl. CPC H04L 63/101; H04L 67/2842
USPC 726/4

(57) ABSTRACT

The present disclosure provides one or network devices having a shared resource that can be remotely accessed by multiple users, also referred to as tenants. The shared resource can be located within one network device or can be spread throughout multiple network devices. One or more resources from among the shared resource can be allocated to one or more corresponding tenants from among the multiple tenants. The one or more corresponding tenants can access their respective resources using one or more commands. The one or network devices can implement an authorization procedure to ensure that the one or more tenants can only access their respective resources. The authorization procedure represents an access control mechanism to grant access to the one or more tenants to only their respective resources.

### CROSS-REFERENCE TO RELATED APPLICATIONS

The present application claims the benefit of U.S. Provisional Patent Appl. No. 61/889,777, filed Oct. 11, 2013, and U.S. Provisional Patent Appl. No. 62/027,817, filed Jul. 23, 2014, each of which is incorporated herein by reference in its entirety.

### BACKGROUND

1. Field of Disclosure

The present disclosure generally relates to accelerating access to resources across a multi-tenant environment.

2. Related Art

With the rapid expansion of the Internet, many new websites have come into existence. These new websites offer web applications, ranging from social media to news reporting, to bring users of these websites a more dynamic online experience. At the heart of these new web applications, as well as many existing web applications, is an organized collection of data in the form of a database. Databases are created to operate upon large quantities of information by inputting, storing, retrieving, and managing the information. A rate at which this information is operated on by the web application is important to the user's interaction with a website executing that the web application. If the rate is too slow, then it may take longer for the web application to execute. For example, it may take longer for the web application to display information stored in the database, thereby frustrating users of the web application. As a result, these frustrated users may not access that web application or even that web site in the future.

Various conventional techniques are available to increase the rate at which the information is stored within and/or retrieved from the database. One such technique is memcaching. Memcaching represents a high performance distributed memory object caching system. One of the primary uses of memcaching is to speed up web applications by using a cache and alleviating a load of the database. In memcaching, information is stored within a single unified cache that is spread across multiple interconnected servers. Web applications can access the information that is stored within the single unified cache across any one of these multiple interconnected servers using a memcache “GET” command. Other memcached commands, such as a memcache “SET” command or a memcache “DELETE” command are also available to assist the web applications to operate upon the information that is stored within the single unified cache.

Another such technique to increase the rate at which the information is stored within and/or retrieved from the database relates to network interface card (NIC) offload. This technique essentially offloads processing of certain tasks that are typically executed a central, or main, processing unit of a computing device, such as a server or a personal computer to provide some examples, onto to a processor of the NIC. Memcached acceleration is a form of offload technology that can be used by one or more of the multiple interconnected servers to offload memcached commands from central processing units of the multiple interconnected servers onto to a processor of the NIC within the multiple interconnected servers. This frees the central processing units of the multiple interconnected servers to perform other tasks. Often times, the most prevalent memcached commands, such as the “GET”, the “SET”, and the “DELETE” commands are often offloaded to the NIC.

### BRIEF DESCRIPTION OF THE DRAWINGS/FIGURES

FIG. 1 graphically illustrates a shared resource infrastructure having a shared resource according to an embodiment of the present disclosure;

FIG. 2 graphically illustrates an exemplary shared resource that can be used within the shared resource infrastructure according to an embodiment of the present disclosure; and

FIG. 3 illustrates a memcache server that can be used within the shared resource infrastructure according to an embodiment of the present disclosure.

The present disclosure will now be described with reference to the accompanying figures. In the drawings, like reference numbers generally indicate identical, functionally similar, and/or structurally similar elements. The figure in which an element first appears is indicated by the leftmost digit(s) in the reference number.

### DETAILED DESCRIPTION

### Overview

The present disclosure provides one or network devices having a shared resource that can be remotely accessed by multiple users, also referred to as tenants. The shared resource can be located within one network device or can be spread throughout multiple network devices. One or more resources from among the shared resource can be allocated to one or more corresponding tenants from among the multiple tenants. The one or more corresponding tenants can access their respective resources using one or more commands. For example, a tenant can provide a read command to the one or network devices having its respective resources to read data from its respective resource segments. As another example, a tenant can provide a write command to the one or network devices having its respective resources to write data to its respective resource segments.

The one or network devices can implement an authorization procedure to ensure that the one or more tenants can only access their respective resources. The authorization procedure represents an access control mechanism to grant access to the one or more tenants to only their respective resources. For example, the one or more network devices can analyze the one or more commands to determine one or more identities of the one or more tenants. In this example, the one or more network devices can grant access to the one or more tenants to their respective resources when the one or more determined identities are associated with their respective resources.

An Exemplary Shared Resource Architecture

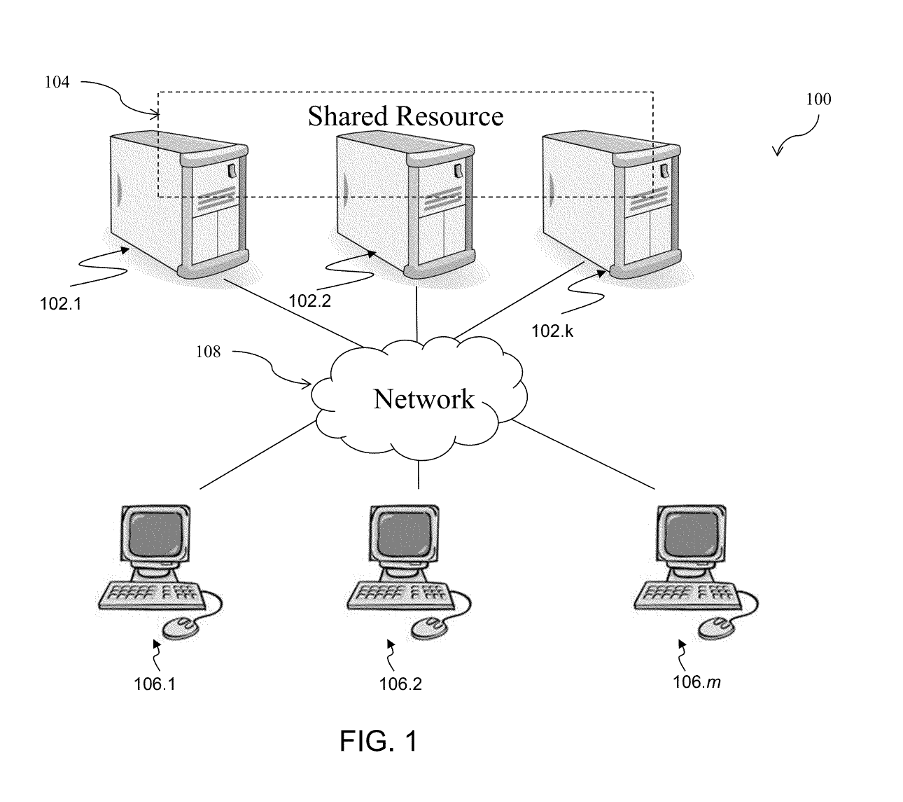

FIG. 1 graphically illustrates a shared resource infrastructure having a shared resource according to an embodiment of the present disclosure. As shown in FIG. 1, a shared resource infrastructure 100 includes one or more shared network devices 102.1 through 102.k having a shared resource 104 that can be remotely accessed by one or more tenants 106.1 through 106.m through a communication network 108. The shared resource 104 can be located within one of the one or more shared network devices 102.1 through 102.k or can be parses throughout the one or more shared network devices 102.1 through 102.k. Examples of the shared resource 104 can include: shared file access, such as shared audio, video, and/or data file access, shared memory access, shared printer access; or shared scanner access to provide some examples.

The one or more shared network devices 102.1 through 102.k can represent one or more computing devices, such as one or more servers, one or more personal computing devices; one or more mobile communication devices, such as one or more cellular phones or one or more tablet computers; one or more gaming consoles; and/or any other suitable device, or devices, that will be apparent to those skilled in the relevant art(s) without departing from the spirit and scope of the present disclosure. Additionally, the one or more shared network devices 102.1 through 102.k can access one or more peripheral devices, such as one or more printers, one or more scanners, one or more external memory storage devices and/or any other suitable device, or devices, that will be apparent to those skilled in the relevant art(s) without departing from the spirit and scope of the present disclosure. The shared resource 104 can represent any hardware resource, such as one or more memory storage devices, the one or more peripheral devices, and/or one or more processing units, and/or any software resource, such one or more executable software applications that are available to the one or more shared network devices 102.1 through 102.k.

Multi-tenancy refers to an architecture where multiple client organizations, such as the tenants 106.1 through 106.m to provide an example, can use a common infrastructure to access the shared resource 104 that is aggregated among the one or more shared network devices 102.1 through 102.k. The one or more shared network devices 102.1 through 102.k can allocate one or more resources from among the shared resource 104 to one or more corresponding tenants 106.1 through 106.m. For example, a shared block of memory storage can be characterized as being separable into multiple blocks of memory storage. In this example, a first block of memory storage from among the shared block of memory storage can be allocated to a first tenant 106.1 and a second block of memory storage from among the shared block of memory storage can be allocated to a second tenant 106.2. In an exemplary embodiment, the one or more shared network devices 102.1 through 102.k can store a listing of the one or more tenants 106.1 through 106.m and their resources from among the shared resource 104.

The one or more corresponding tenants 106.1 through 106.m can access their respective resources using one or more commands to request access to one or more resources. The one or more corresponding tenants 106.1 through 106.m can represent one or more computing devices, such as one or more servers, one or more personal computing devices; one or more mobile communication devices, such as one or more cellular phones or one or more tablet computers; one or more gaming consoles; and/or any other suitable device, or devices, that will be apparent to those skilled in the relevant art(s) without departing from the spirit and scope of the present disclosure. From the example above, the first tenant 106.1 can provide a read and/or a write command to the one or more shared network devices 102.1 through 102.k to request access to the first block of memory storage and the second tenant 106.2 can provide the read and/or the write command to the one or more shared network devices 102.1 through 102.k to request access to the second block of memory storage.

The one or more shared network devices 102.1 through 102.k can implement an authorization procedure to ensure that the one or more tenants 106.1 through 106.m can only access their respective resources from among the shared resource 104. The authorization procedure represents an access control mechanism to grant access to the one or more tenants 106.1 through 106.m to only their respective resources. The authorization procedure prevents one or more tenants 106.1 through 106.m from accessing resources that are allocated to other tenants 106.1 through 106.m. For example, the one or more shared network devices 102.1 through 102.k can analyze the one or more commands to determine one or more identities of the one or more tenants 106.1 through 106.m that provided the one or more commands. The one or more identities can include one or more source addresses of the one or more commands or one or more tenant identifiers (ID) of the one or more commands to provide some examples. Thereafter, the one or more shared network devices 102.1 through 102.k can grant access to the one or more tenants 106.1 through 106.m to the one or more requested resources when the one or more determined identities are associated with the one or more requested resources. Alternatively, or in addition to, the one or more shared network devices 102.1 through 102.k can deny access to the one or more tenants 106.1 through 106.m to the one or more requested resources when the one or more determined identities are not associated with the one or more requested resources. Often times, in this situation, the one or more requested resources are allocated to other tenants 106.1 through 106.m.

Additionally, the one or more shared network devices 102.1 through 102.k can physically or logically isolate resources allocated to each of the one or more tenants 106.1 through 106.m. The physical isolation of the resources allocated to each of the one or more tenants 106.1 through 106.m involves separation of the resources between the one or more shared network devices 102.1 through 102.k. For example, a shared block of memory storage can be characterized as being separable into multiple blocks of memory storage. In this example, a first block of memory storage to be allocated to a first tenant 106.1 can be located in a first shared network device 102.1 which is isolated from a second block of memory storage, located in a second shared network device 102.2, to be allocated to a second tenant 106.2.

The logical isolation of the resources allocated to each of the one or more tenants 106.1 through 106.m involves utilizing one or more security keys by the one or more tenants 106.1 through 106.m to access their respective resources. The one or more tenants 106.1 through 106.m can include their corresponding security keys within the one or more commands when requesting access to the one or more resources. The one or more shared network devices 102.1 through 102.k can compare the one or more security keys provided by the one or more tenants 106.1 through 106.m to a lookup table of security keys to determine whether to grant access to the one or more resources. The one or more shared network devices 102.1 through 102.k can store separate security key-value lookup tables for the one or more tenants 106.1 through 106.m; store a single shared lookup table for the one or more tenants 106.1 through 106.m, such that each security key in the lookup table is made by concatenation of an original security key provided to the one or more tenants 106.1 through 106.m and a corresponding tenant ID; or store a single shared lookup table for the one or more tenants 106.1 through 106.m such that each security key in the lookup table is made by concatenation of metadata for a corresponding tenant 106.1 through 106.m and an original security key provided to the one or more tenants 106.1 through 106.m.

Thereafter, the one or more shared network devices 102.1 through 102.k can grant access to the one or more tenants 106.1 through 106.m to the one or more requested resources when the one or more security keys are associated with the one or more requested resources. Alternatively, or in addition to, the one or more shared network devices 102.1 through 102.k can deny access to the one or more tenants 106.1 through 106.m to the one or more requested resources when the one or more security keys are not associated with the one or more requested resources.

An Exemplary Multi-Tenancy Infrastructure

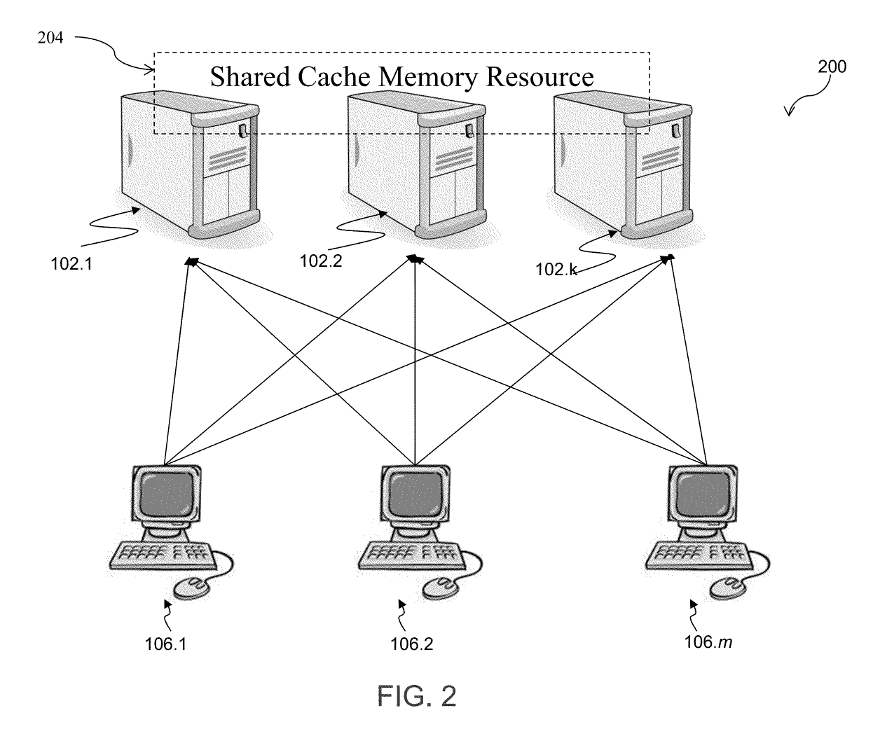

FIG. 2 graphically illustrates an exemplary shared resource that can be used within the shared resource infrastructure according to an embodiment of the present disclosure. As shown in FIG. 2, a shared resource infrastructure 200 includes the one or more shared network devices 102.1 through 102.k having a shared cache memory resource 204 that can be remotely accessed by the one or more tenants 106.1 through 106.m. The shared cache memory resource 204 can represent an exemplary embodiment of the shared resource 104.

As illustrated in FIG. 2, the shared cache memory 204 represents an aggregation of cache memories of the one more shared network devices 102.1 through 102.k which is accessible by the one or more tenants 106.1 through 106.m. Typically, a corresponding shared network device 102.1 through 102.k can service a request for data that is stored within a cache memory, often referred to as a cache hit, by simply reading its cache memory. However, to service a request for data that is not stored within the cache memory, often referred to as a cache miss, the corresponding shared network device 102.1 through 102.k re-computes or fetches the data from its original storage location within the corresponding shared network device 102.1 through 102.k. The corresponding shared network device 102.1 through 102.k needs more time to re-compute or fetch the data from its original storage location often requires more time than simply reading the data from its cache memory.

The one or more shared network devices 102.1 through 102.k can allocate one or more blocks of cache memory from among the shared cache memory resource 204 to one or more corresponding tenants 106.1 through 106.m. For example, the shared cache memory resource 204 can be characterized as being separable into multiple blocks of cache memory storage. In this example, a first block of cache memory storage from among the shared block of memory storage can be allocated to a first tenant 206.1 and a second block of memory storage from among the shared block of memory storage can be allocated to a second tenant 106.2. In an exemplary embodiment, the one or more shared network devices 102.1 through 102.k can store a listing of the tenants 104.1 through 104.m and their allocated one or more blocks of cache memory from among the shared cache memory resource 204.

Memcaching represents a high performance distributed memory object caching system that can be used within the shared resource infrastructure 200 to allow the one or more tenants 106.1 through 106.m to access their allocated one or more blocks of cache memory from among the shared cache memory resource 204. The one or more tenants 106.1 through 106.m can send a memcache “GET” command to one of the shared network devices 102.1 through 102.k to access data that is stored with a corresponding cache memory from among the shared cache memory 204. Other memcached commands, such as a memcache “SET” command or a memcache “DELETE” command are also available to assist the one or more tenants 106.1 through 106.m to operate upon data that is stored with the corresponding cache memory.

The one or more shared network devices 102.1 through 102.k can implement an authorization procedure to ensure that the one or more tenants 106.1 through 106.m can only access their allocated one or more blocks of cache memory. The authorization procedure represents an access control mechanism to grant access to the one or more tenants 106.1 through 106.m to only their allocated one or more blocks of cache memory. The authorization procedure prevents one or more tenants 106.1 through 106.m from accessing blocks of cache memory that are allocated to other tenants 106.1 through 106.m. For example, the one or more shared network devices 102.1 through 102.k can analyze the one or more commands from the one or more tenants 106.1 through 106.m requesting access to their allocated one or more blocks of cache memory. These one or more commands can include memcached command, such as the memcache “GET” command, the memcache “SET” command, the memcache “DELETE”, or any other memcached command that will be apparent to one skilled in the relevant art(s) without departing from the spirit and scope of the present disclosure. The one or more shared network devices 102.1 through 102.k can determine one or more identities of the one or more tenants 106.1 through 106.m that provided the one or more commands. The one or more identities can include one or more source addresses of the one or more commands or one or more tenant identifiers (ID) of the one or more commands to provide some examples. Thereafter, the one or more shared network devices 102.1 through 102.k can grant access to the one or more tenants 106.1 through 106.m to the one or more requested blocks of cache memory when the one or more determined identities are associated with their allocated one or more blocks of cache memory. Alternatively, or in addition to, the one or more shared network devices 102.1 through 102.k can deny access to the one or more tenants 106.1 through 106.m to the one or more requested blocks of cache memory when the one or more determined identities are not associated with their allocated one or more blocks of cache memory. Often times, in this situation, the one or more requested blocks of cache memory are allocated to other tenants of the one or more tenants 106.1 through 106.m.

In an exemplary embodiment, the authorization procedure can utilize one or more security keys to ensure that the one or more tenants 106.1 through 106.m can only access their allocated one or more blocks of cache memory. The one or more tenants 106.1 through 106.m can include their corresponding security keys within the one or more commands when requesting access to the one or more blocks of cache memory. The one or more shared network devices 102.1 through 102.k can compare the one or more security keys provided by the one or more tenants 106.1 through 106.m to a lookup table of security keys to determine whether to grant access to the one or more blocks of cache memory. The one or more shared network devices 102.1 through 102.k can store separate security key-value lookup tables for the one or more tenants 106.1 through 106.m; store a single shared lookup table for the one or more tenants 106.1 through 106.m, such that each security key in the lookup table is made by concatenation of an original security key provided to the one or more tenants 106.1 through 106.m and a corresponding tenant ID; or store a single shared lookup table for the one or more tenants 106.1 through 106.m such that each security key in the lookup table is made by concatenation of metadata for a corresponding tenant 106.1 through 106.m and an original security key provided to the one or more tenants 106.1 through 106.m. The one or more shared network devices 102.1 through 102.k can grant access to the one or more tenants 106.1 through 106.m to the one or more requested blocks of cache memory when the one or more security keys provided by the one or more tenants 106.1 through 106.m are associated with one or more security keys of the one or more requested blocks of cache memory.

Additionally, the one or more shared network devices 102.1 through 102.k can physically and/or logically isolate blocks of cache memory allocated to each of the one or more tenants 106.1 through 106.m. The physical isolation of the blocks of cache memory allocated to each of the one or more tenants 106.1 through 106.m involves a physical separation of the blocks of cache memory between the one or more shared network devices 102.1 through 102.k. For example, a shared block of memory storage can be characterized as being separable into multiple blocks of memory storage. In this example, a first block of memory storage to be allocated to a first tenant 106.1 can be located in a first shared network device 102.1 which is isolated from a second block of memory storage, located in a second shared network device 102.2, to be allocated to a second tenant 106.2. The logical isolation of the blocks of cache memory allocated to each of the one or more tenants 106.1 through 106.m involves a logical separation of the blocks of cache memory within each of the one or more shared network devices 102.1 through 102.k. For example, a shared block of memory storage can be characterized as being separable into multiple blocks of memory storage. In this example, a first block of memory storage to be allocated to a first tenant 106.1 can be located in a first shared network device 102.1 which is logically isolated from a second block of memory storage, located in the first shared network device 102.1, to be allocated to a second tenant 106.2.

An Exemplary Memcache Server Architecture

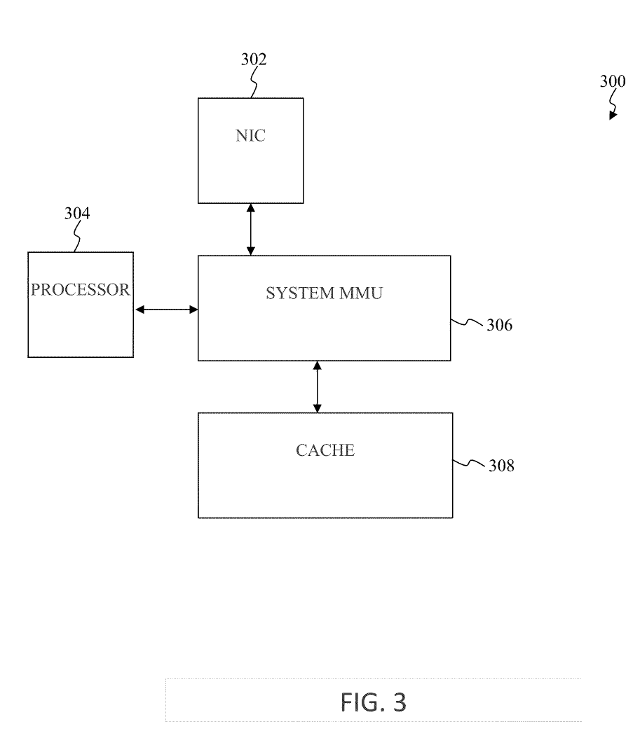

FIG. 3 illustrates a memcache server that can be used within the shared resource infrastructure according to an embodiment of the present disclosure. A memcache server 300 includes a portion of a shared cache memory resource, such as the shared cache memory resource 204 to provide an example, which is accessible by one or more tenants, such as the one or more tenants 106.1 through 106.m to provide an example, within a shared resource infrastructure. The memcached server 300 includes, one or more network interface cards (NICs) 302, one or more central processing units (CPUs) 304, a system memory management unit 306, and a shared cache memory 308. The memcache server 300 can represent an exemplary embodiment of one or more of the one or more shared network devices 102.1 through 102.k.

The one or more NICs 302 can receive one or more requests to access to the one or more blocks of cache memory within the shared cache memory 308 from one or more tenants and can provide one or more responses to the one or more requests. The one or more NICs 302 can analyze the one or more requests to determine whether the one or more requests and/or one or commands within the one or more requests are to be processed locally by the one or more NICs 302 or are to be forwarded onto the one or more CPUs 304 for remote processing. In an exemplary embodiment, the one or more NICs 302 can implemented the authorization procedure as discussed above to ensure that tenants can only access their allocated one or more blocks of the shared cache memory 308.

The NIC offload technology effectively parses processing that is conventionally performed entirely be a conventional CPU between the one or more NICs 302 and the one or more CPUs 304. For example, when the one or more requests include a memcache “GET” command, the one or more NICs 302 can locally process the memcache “GET” command and provide a response thereto without passing the memcache “GET” command onto the one or more CPUs 304. It should be noted that this example is not limiting, those skilled in the relevant art(s) will recognize that other commands received by one or more NICs 302 can be processed in a substantially similar manner without departing from the spirit and scope of the present disclosure.

The one or more NICs 302 can operate on the one or more blocks of cache memory within the shared cache memory 308 in response to the one or more requests and/or the one or commands. These operations can include setting of data to be stored within the shared cache memory 308, replacing, appending, prepending, retrieving, and/or deleting data stored within the shared cache memory 308, or any other suitable operation that will be apparent to those skilled in the relevant art(s) without departing from the spirit and scope of the present disclosure.

The one or more CPUs 304 control overall operation and/or configuration of the memcached server 300. The one or more CPUs 304 carry out the instructions of a computer program by performing basic arithmetical, logical, and input/output operations of the memcache server 300. Typically, the one or more CPUs 304 can include an arithmetic logic unit (ALU) to perform arithmetic and logical operations and/or a control unit (CU) to extract, decode, and execute instructions stored within the shared cache memory 308 or elsewhere within the memcached server 300.

Additionally, the one or more CPUs 304 can process one or more or more requests and/or one or commands within the one or more requests that are provided by the one or more NICs 302 and can provide one or more responses to the one or more NICs 302 for the one or more requests. For example, when the one or more requests include a memcache “SET” command or a memcache “DELETE” command, the one or more NICs 302 can provide these commands to the one or more CPUs 304 for processing. In this example, the one or more CPUs 304 can process these commands and can provide one or more responses to the one or more NICs 302 for these commands. The one or more CPUs 304 can operate on the one or more blocks of cache memory within the shared cache memory 308 in response to the one or more requests and/or the one or commands. These operations can include setting of data to be stored within the shared cache memory 308, replacing, appending, prepending, retrieving, and/or deleting data stored within the shared cache memory 308, or any other suitable operation that will be apparent to those skilled in the relevant art(s) without departing from the spirit and scope of the present disclosure. In an exemplary embodiment, the one or more CPUs 304 can implemented the authorization procedure as discussed above to ensure that tenants can only access their allocated one or more blocks of the shared cache memory 308.

The system memory management unit 306 performs translation between virtual memory addresses and physical addresses to allow the one or more NICs 302 and/or the one or more CPUs 304 to access the one or more blocks of the shared cache memory 308. The system memory management unit 306 can also manage the shared cache memory 308 as well as memory protection, cache control, or bus arbitration to provide some examples.

The shared cache memory 308 includes a portion of a shared cache memory that is shared between multiple shared network devices, such as multiple memcached servers 300 to provide an example. This portion of the shared cache memory includes one or more blocks of memory that can be allocated to the one or more tenants. This portion in its entirety can be allocated to one of the one or more tenants or can be allocated to multiple tenants from among the one or more tenants.

### CONCLUSION

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It will be apparent to those skilled in the relevant art(s) that various changes in form and detail can be made therein without departing from the spirit and scope of the disclosure. Thus the present disclosure should not be limited by any of the above-described embodiments.

What is claimed is:

1. A system for accessing a shared resource, the system comprising:
a first shared network device communicatively coupled to a plurality of tenants; and
a second shared network device communicatively coupled to the plurality of tenants,
wherein the shared resource is parsed between the first shared network device and the second network device,
wherein a first portion of the shared resource is allocated to a first tenant from among the plurality of tenants and a second portion of the shared resource is allocated to a second tenant from among the plurality of tenants, and
wherein the first and the second shared network device are configured to implement an authorization procedure to ensure that the first and the second tenants can only access their corresponding portions of the shared resource.

2. The system of claim 1, wherein the first and the second shared network device are configured to grant access to the first portion of the shared resource to the first tenant when the authorization procedure indicates that the first tenant is requesting to only access its allocated first portion of the shared resource and to the second portion of the shared resource to the second tenant when the authorization procedure indicates that the second tenant is requesting to only access its allocated first portion of the shared resource.

3. The system of claim 1, wherein the shared resource comprises:
a first cache memory that is implemented within the first shared network device; and
a second cache memory that is implemented within the second shared network device.

4. The system of claim 1, wherein the first shared network device is further configured to:
receive a request to access the first portion of the shared resource of from the first tenant;
determine an association between an identity of a tenant from among the plurality of tenants that provided the request and the first portion of the shared resource; and
grant access to the first tenant to the first portion of the shared resource when the identity is associated with the first portion of the shared resource.

5. The system of claim 4, wherein the request comprises:
a security key provided by the first tenant, and
wherein the first shared network device is configured to match the security key to a plurality of securities keys to determine the association.

6. The system of claim 1, wherein the first shared network device is further configured to:
receive a request to access the first portion of the shared resource of from the second tenant;
determine an association between an identity of a tenant from among the plurality of tenants that provided the request and the first portion of the shared resource; and
deny access to the second tenant to the first portion of the shared resource when the identity is not associated with the first portion of the shared resource.

7. The system of claim 6, wherein the request comprises:
a security key provided by the first tenant, and
wherein the first shared network device is configured to match the security key to a plurality of securities keys to determine the association.

8. A memcache server with a shared resource infrastructure that parses a shared resource among a plurality of memcache servers, the memcache server comprising:
a network interface card configured to receive a request to access the shared resource having a memcache command and to determine whether to process the request locally or to forward the request to be remotely processed based upon the memcache command; and
a central processing unit configured to receive the request when the request to is be remotely processed.

9. The memcache server of claim 8, wherein the network interface card is further configured to process the request and to provide a response to the request when the request is determined to be processed locally.

10. The memcache server of claim 8, wherein the central processing unit is further configured to process the request and to provide a response to the request to the network interface care when the request is determined to be processed remotely.

11. The memcache server of claim 8, further comprising:
a cache memory having a plurality of blocks for storing data, a first group of blocks from among the plurality of blocks being allocated to a first tenant from among a plurality of tenants and a second group of blocks from among the plurality of blocks being allocated to a second tenant from among the plurality of tenants.

12. The memcache server of claim 8, wherein the network interface card is configured to implement an authorization procedure to ensure that a tenant that provided the request to access can only access the its corresponding portions of the shared resource and to grant access to the shared resource to the tenant when the authorization procedure indicates that the tenant is requesting to only access its allocated portion of the shared resource.

13. The memcache server of claim 8, wherein the central processing unit is configured to implement an authorization procedure to ensure that a tenant that provided the request to access can only access its corresponding portions of the shared resource and to grant access to the shared resource to the tenant when the authorization procedure indicates that the tenant is requesting to only access its allocated portion of the shared resource.

14. The memcache server of claim 8, wherein the request comprises:
a memcache “GET” command, and
wherein the network interface card is configured to process the request locally or to forward the request to be remotely processed based upon the memcache “GET” command.

15. The memcache server of claim 8, wherein the request comprises:
a security key provided by a tenant from among a plurality of tenants,
wherein the network interface card is further configured to compare the security key provided by the tenant with a corresponding security key that is associated with the shared resource to determine whether to grant access to the tenant when the request is determined to be processed locally, and
wherein the central processing unit is further configured to compare the security key provided by the tenant with a corresponding security key that is associated with the shared resource to determine whether to grant access to the tenant when the request is determined to be processed remotely.

16. A method for accessing a shared resource that is parsed between shared network device from among a plurality of shared network devices, the method comprising:
allocating a first portion of the shared resource to a first tenant from among the plurality of tenants and a second portion of the shared resource to a second tenant from among the plurality of tenants,
receiving a request to access the first portion of the shared resource from the first tenant;
implementing an authorization procedure to ensure that the first and the second tenants can only access their corresponding portions of the shared resource in response to the request; and
granting access to the first portion of the shared resource to the first tenant when the authorization procedure indicates that the first tenant is requesting to only access the first portion of the shared resource.

17. The method of claim 16, further comprising:
denying access to the first portion of the shared resource to the second tenant when the authorization procedure indicates that the second tenant is requesting to access the first portion of the shared resource.

18. The method of claim 16, wherein the implementing comprises:
comparing a security key provided by the first tenant with a corresponding security key that is associated with the first portion of the shared resource; and
granting access to the first tenant to the shared resource when the security key provided by the first tenant matches the corresponding security key that is associated with the first portion of the shared resource.

19. The method of claim 16, wherein the implementing comprises:
comparing a security key provided by the first tenant with a corresponding security key that is associated with the first portion of the shared resource; and
denying access to the first tenant to the shared resource when the security key provided by the first tenant does not match the corresponding security key that is associated with the first portion of the shared resource.

20. The method of claim 16, wherein the shared resource is a cache memory, and
wherein the allocating comprises:
allocating a first group of blocks from among the plurality of blocks to allocated to the first tenant and a second group of blocks from among the plurality of blocks to a second tenant from among the plurality of tenants.
